(19) United States
(12) Patent Application Publication
(10) Pub. No.: US 2015/0100573 A1
(43) Pub. Date: Apr. 9, 2015

(54) METHOD FOR PROCESSING DATA

(71) Applicant: FUJITSU LIMITED, Kawasaki-shi (JP)

(72) Inventors: Hiroki Moue, Kawasaki (JP); Yuichi Tsuchimoto, Kawasaki (JP); Hiromichi Kobashi, London (GB); Miho Murata, Kawasaki (JP); Yasuo Yamane, Machida (JP); Toshiaki Saeki, Kawasaki (JP)

(73) Assignee: FUJITSU LIMITED, Kawasaki-shi (JP)

(21) Appl. No.: 14/484,657

(22) Filed: Sep. 12, 2014

(30) Foreign Application Priority Data
Oct. 3, 2013 (JP) 2013-208502

(51) Int. Cl. G06F 17/30

(52) U.S. Cl. CPC G06F 17/30424
USPC 707/736

(57) ABSTRACT

A plurality of computers dispersedly store pieces of data and pieces of depository information of the respective pieces of data. The depository information indicates a depository computer storing data of the pieces of data. A first computer of the plurality of computers stores, when depository information of first data is absent in a first storing unit of the first computer, first depository information in the first storing unit. The first depository information indicates the first computer as a first depository computer storing the first data. The first data is stored in a second storing unit of the first computer. The first computer identifies, by searching the first storing unit, a second computer as a second depository computer storing second data to be manipulated in association with third data stored in the second storing unit.

### CROSS-REFERENCE TO RELATED APPLICATION

This application is based upon and claims the benefit of priority from the prior Japanese Patent Application No. 2013-208502 filed on Oct. 3, 2013, the entire contents of which are incorporated herein by reference.

### FIELD

The embodiments discussed herein are related to a method for processing data.

### BACKGROUND

A conventional type of data group management has been known in which respective data constituting a data group are distributed over a plurality of nodes based on a predetermined distribution rule.

FIG. 1 is a diagram illustrating exemplary data groups to be dispersedly managed. In FIG. 1, a table Ta and a table Tb are illustrated. The table Ta includes, for example, an item A and the table Tb includes, for example, an item B and an item X. A plurality of records are registered with each table. Here, respective record groups of the table Ta and the table Tb correspond to the data groups that are dispersedly managed over a plurality of nodes.

FIG. 2 is a diagram illustrating an example in which respective records of each table are distributed over a plurality of nodes. In FIG. 2, an example in which the respective record groups of the table Ta and the table Tb are distributed over the node N1 to node N6 is illustrated. For example, the records of the table Ta are distributed over the node N1 to node N6 based on a hash value of the item A. In other words, the table Ta is divided into the table Ta1 to the table Ta6, and respective tables Ta1 to Ta6 after the division are managed by nodes different from one another. The records of the table Tb are distributed over the node N1 to node N6 based on a hash value of the item B. In other words, the table Tb is divided into the table Tb1 to the table Tb6, and respective tables Tb1 to Tb6 after the division are managed by nodes different from one another.

A case is assumed in which a request to perform a predetermined manipulation is made over the table Ta and the table Tb in a state illustrated in FIG. 2. For example, it is assumed that a request of joining the table Ta with the table Tb is made based on the commonality between the value of the item A and the value of the item X. In this case, the value of the item A participates in the distribution of the records but the value of the item X does not participate in the distribution of the records. That is, the commonality between the value of the item A and the value of the item X is not taken into account in each record distribution of the table Ta and the table Tb. Therefore, an average amount of communication between nodes needed for the joining is {(the number of nodes−1)÷the number of nodes} with respect to the amount of joined data. When all the data is to be joined, the amount of communication is {(the number of nodes−1)÷the number of nodes} with respect to the total amount of data. In the example of FIG. 2, since the number of nodes is 6, the amount of communication is {(6−1)÷6} with respect to the total amount of data. Further, the {(the number of nodes−1)÷the number of nodes} also corresponds to the amount of communication with respect to the amount of stored data at each node on average.

A related technique is disclosed in, for example, Japanese Laid-Open Patent Publication No. 2011-216029.

It may be considered that the records are moved such that the joined records are stored in the same node in order to reduce the amount of communication described above.

However, when the records are moved, the distribution rule for records is not preserved. Accordingly, it becomes difficult to identify a depository node of a record based on the distribution rule. In such a case, a certain node is required to inquire of other respective nodes about the location of a record to be manipulated (e.g., becomes a counterpart for joining records) in association with a record managed by the certain node in order to identify a depository node of the record. As a result, the amount of communication for inquiry increases.

### SUMMARY

According to an aspect of the present invention, provided is a method for processing data. In the method, a plurality of computers dispersedly store pieces of data and pieces of depository information of the respective pieces of data. The depository information indicates a depository computer storing data of the pieces of data. A first computer of the plurality of computers stores, when depository information of first data is absent in a first storing unit of the first computer, first depository information in the first storing unit. The first depository information indicates the first computer as a first depository computer storing the first data. The first data is stored in a second storing unit of the first computer. The first computer identifies, by searching the first storing unit, a second computer as a second depository computer storing second data to be manipulated in association with third data stored in the second storing unit.

The objects and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating exemplary data groups to be dispersedly managed;

FIG. 2 is a diagram illustrating an example in which respective records of each table are distributed over a plurality of nodes;

FIG. 3 is a diagram illustrating an exemplary system configuration according to an embodiment;

FIG. 4 is a diagram illustrating an exemplary hardware configuration of a data management node according to an embodiment;

FIG. 5 is a diagram illustrating an exemplary functional configuration of a data management node according to an embodiment;

FIG. 6 is a flowchart of an exemplary processing sequence performed by a data management node in response to a table joining request;

FIG. 7 is a diagram illustrating exemplary stored contents of depository information storing units in respective data management nodes;

FIG. 8 is a flowchart of an exemplary processing sequence performed by a data management node in response to a data registration request received from another node;

FIG. 9 is a diagram illustrating an example of change in distribution state of a record Ra, a record Rb, and depository information; and

FIG. 10 is a flowchart of an exemplary processing sequence for a collective generation process of depository information.

### DESCRIPTION OF EMBODIMENTS

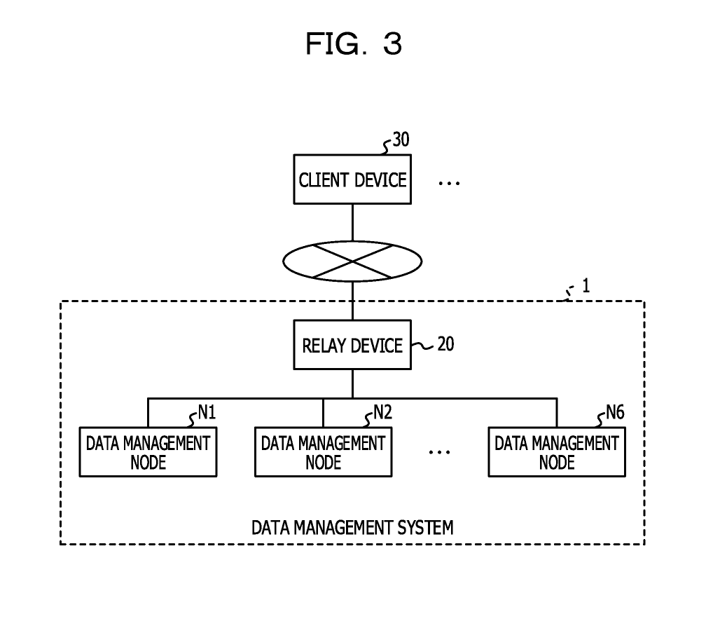

Hereinafter, embodiments will be described with reference to accompanying drawings. FIG. 3 is a diagram illustrating an exemplary system configuration according to an embodiment. In FIG. 3, a data management system 1 is communicably connected with at least one client device 30 through a network, such as a local area network (LAN) or the Internet. The network may include a wireless zone.

The client device 30 may be, for example, a personal computer (PC), a smart phone, a tablet type terminal and a portable phone. The client device 30 receives a data manipulation request from a user and transmits the manipulation request to the data management system 1. When a manipulation result in response to the manipulation request is replied from the data management system 1, the client device 30 displays the manipulation result. The client device 30 may be a computer such as a web server that receives a data manipulation request from a terminal directly operated by the user. Examples of the data manipulation may include, for example, a data retrieval (referencing) or data update (recording). The data retrieval may include selection, projection, or joining regarding tables in which data are registered.

The data management system 1 is a computer system which includes a plurality of computers that manage data to be manipulated. In FIG. 3, the data management system 1 includes, for example, a relay device 20 and data management nodes N1 to N6. Hereinafter, when each of the data management nodes N1 to N6 is not discriminated, the data management nodes N1 to N6 are collectively referred to as a “data management node N”. The number of data management nodes N (the number of nodes) may be either less than 6 (six) or greater than or equal to 7 (seven).

The relay device 20 receives a data manipulation request from the client device 30 and causes data management nodes N to perform a processing in response to the manipulation request. The relay device 20 also integrates processing results by data management nodes N as needed and replies the integrated processing results to the client device 30. The relay device 20 may be one of the data management nodes N.

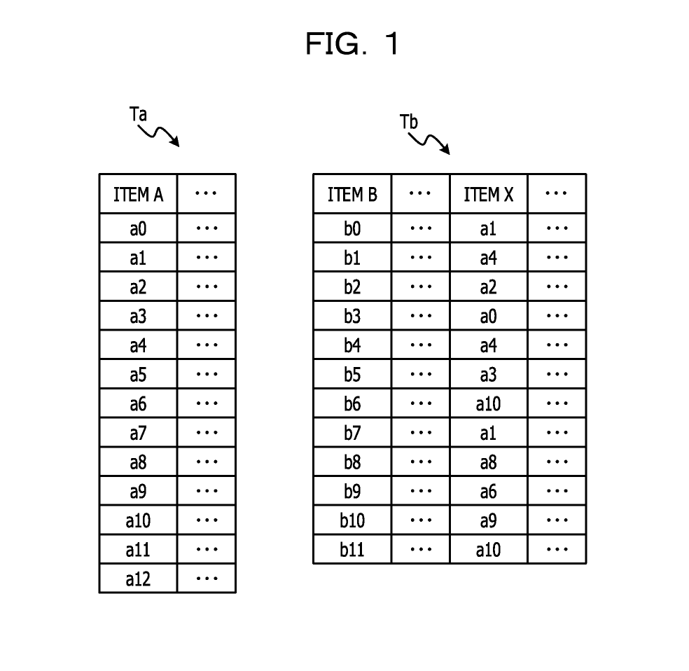

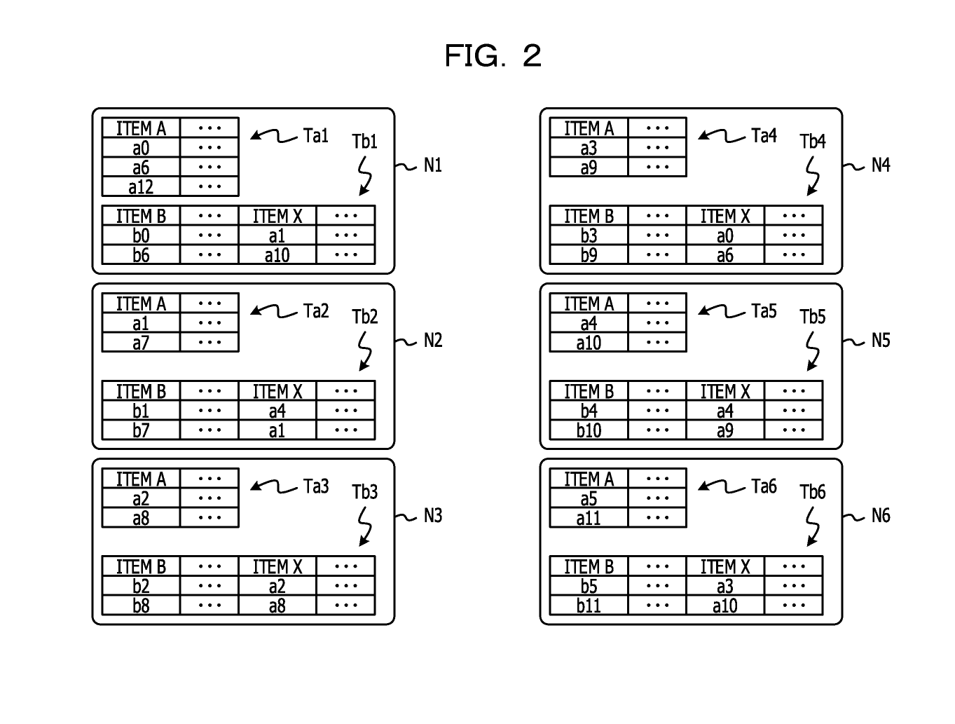

Each of the data management nodes N is a computer which dispersedly manages the data groups. In the present embodiment, it is assumed that a record group of the table Ta and a record group of the table Tb illustrated in FIG. 1 correspond to the dispersedly managed data. Specifically, the record group of the table Ta and the record group of the table Tb are distributed over the nodes N1 to N6 to be managed as illustrated in FIG. 2. The record groups are distributed in accordance with a predetermined distribution rule. For example, a data management node N as a depository (storage destination) for a record (hereinafter, referred to as a “record Ra”) of the table Ta is determined based on a hash value of the item A. A data management node N as a depository for a record (hereinafter, referred to as a “record Rb”) of the table Tb is determined based on a hash value of the item B. However, respective records may be distributed in accordance with other distribution rules. A distribution rule refers to a rule for determining a depository of a record. Accordingly, the depository of the record may be identified in accordance with the distribution rule. For example, a data management node N as a depository of a record Ra may be identified based on a hash value of the item A of the record Ra. In the present embodiment, “management” of data by the data management node N includes the meaning of “storing” of data. However, a storage device which actually stores data may be a device which is external to the data management node N.

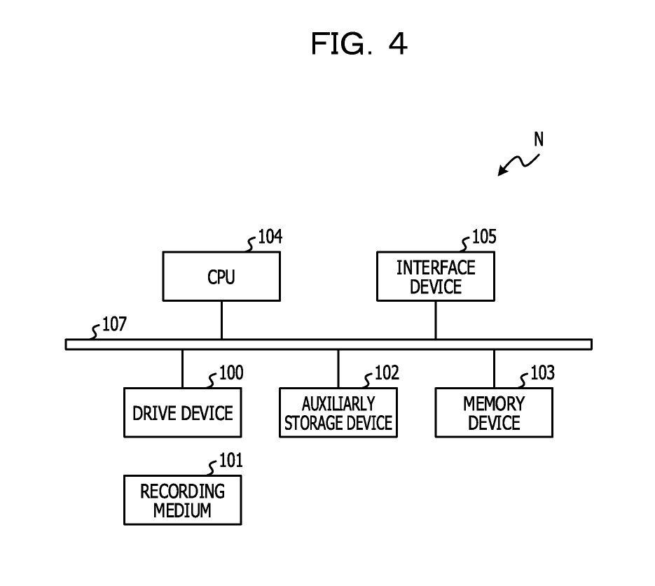

FIG. 4 is a diagram illustrating an exemplary hardware configuration of a data management node according to the present embodiment. The data management node N of FIG. 4 includes, for example, a drive device 100, an auxiliary storage device 102, a memory device 103, a central processing unit (CPU) 104 and an interface device 105 that are connected with one another via a bus 107.

A program (a data processing program) for implementing a processing in the data management node N is provided by a recording medium 101. When the recording medium 101 that stores the program is set in the drive device 100, the program is installed from the recording medium 101 to the auxiliary storage device 102 through the drive device 100. However, the program is not necessarily installed from the recording medium 101 and may be downloaded from another computer through a network. The auxiliary storage device 102 stores the installed program as well as necessary files or data.

When an instruction to start the program is issued, the program is read from the auxiliary storage device 102 and stored in the memory device 103. The CPU 104 executes the program stored in the memory device 103 so as to implement functions of the data management node N. The interface device 105 is used as an interface for connecting to the network.

Examples of the recording medium 101 may include a portable recording medium such as compact disc read-only memory (CD-ROM), a digital versatile disc (DVD), or a universal serial bus (USB) memory. Examples of the auxiliary storage device 102 may include a hard disk drive (HDD) or a flash memory. Any of the recording medium 101 and the auxiliary storage device 102 corresponds to a computer-readable recording medium.

The relay device 20 may also have a hardware configuration similar to the configuration illustrated in FIG. 4.

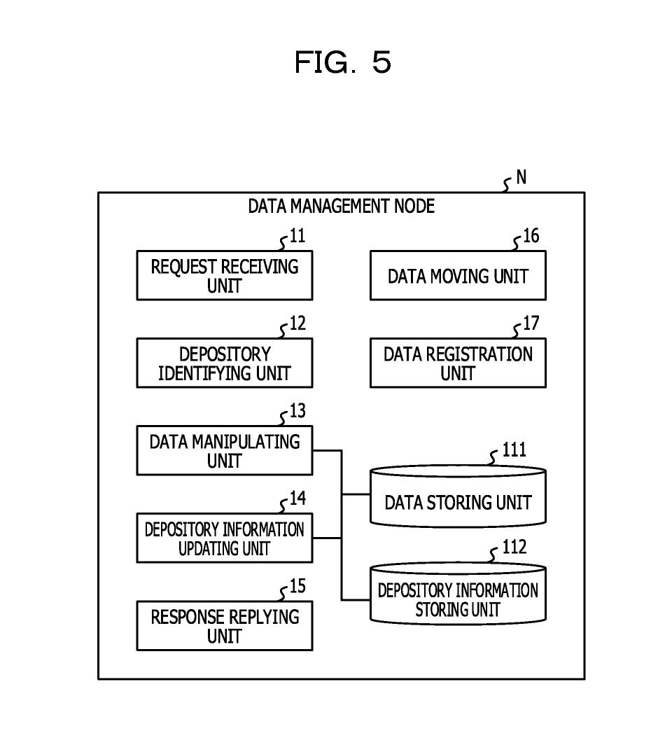

FIG. 5 is a diagram illustrating an exemplary functional configuration of the data management node according to the present embodiment. In FIG. 5, the data management node N includes, for example, a request receiving unit 11, a depository identifying unit 12, a data manipulating unit 13, a depository information updating unit 14, a response replying unit 15, a data moving unit 16 and a data registration unit 17. Each of these components is implemented by the CPU 104 through execution of the program installed in the data management node N. The data management node N uses, for example, a data storing unit 111 and a depository information storing unit 112. The data storing unit 111 and the depository information storing unit 112 may be implemented by using, for example, the auxiliary storage device 102 or a storage device connected to the data management node N through the network.

The data storing unit 111 stores therein the table Ta and the table Tb. That is, the data storing unit 111 stores therein data to be managed or to be manipulated. The depository information storing unit 112 stores therein information (hereinafter, referred to as “depository information”) indicating a data management node N as a depository for each record Ra and each record Rb. In the present embodiment, a data management node N as a depository of each of the record Ra and the record Rb is determined based on a hash value of the item A or a hash value of the item B at the time of an initial registration. However, as will be described, a location of placement (depository) of the record Rb may be changed in response to a data manipulation request to the data management system 1. Accordingly, there is no guarantee that the location of placement of the record Rb may be identified in accordance with the distribution rule. In such a case, inquiring of all the data management nodes N may be needed for identifying the location of placement of a certain record Rb and thus, increase in the amount of communication is anticipated. Accordingly, the depository information storing unit 112 is prepared in the present embodiment. That is, it is possible to suppress the increase in the amount of communication for identifying a node (hereinafter, referred to as a “depository node”) as a depository for the record Ra or the record Rb by using the information stored in the depository information storing unit 112.

The request receiving unit 11 receives a data manipulation request from the relay device 20. The depository identifying unit 12 identifies a depository node of data to be manipulated. The data manipulating unit 13 performs a manipulation requested for the record Ra and the record Rb. The depository information updating unit 14 updates the depository information, for example, when the location of placement of the record Rb is changed due to a data manipulation. The response replying unit 15 replies a response to the data manipulation request received by the request receiving unit 11.

The data moving unit 16 moves a record Rb to be manipulated in the processing according to the data manipulation request to a data management node N in which a record Ra to be manipulated in association with the record Rb is placed. The movement of the record Rb indicates that the location of placement (depository node) of the record Rb is changed. The data registration unit 17 registers a record Rb transmitted from a data moving unit 16 of another node, with the table Tb in the data storing unit 111 of its own node.

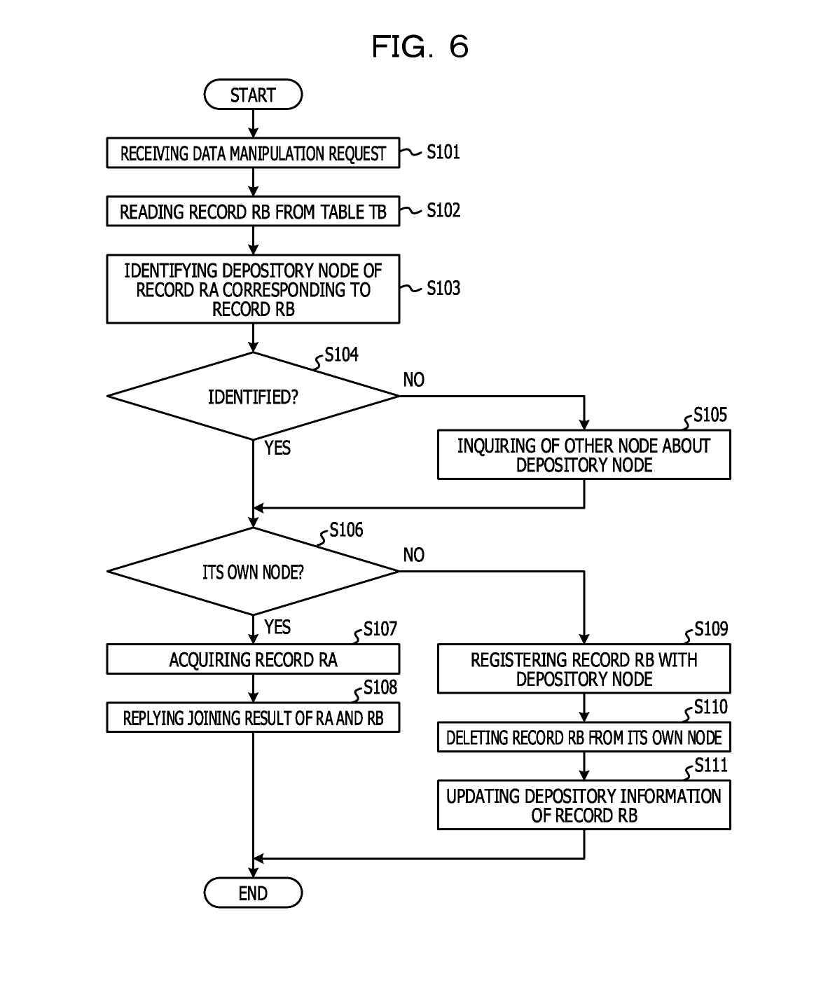

Hereinafter, the processing sequence performed by the data management node N will be described. FIG. 6 is a flowchart of an exemplary processing sequence performed by a data management node in response to a table joining request.

At S101, the request receiving unit 11 receives a data manipulation request from the relay device 20. Here, it is assumed that the manipulation of joining the table Ta with the table Tb, based on the commonality between the value of the item A of the table Ta and the value of the item B of the table Tb, is requested. Hereinafter, the manipulation request of joining the table Ta and the table Tb is simply referred to as a “joining request”. The manipulation request received from the relay device 20 may be a request either received by the relay device 20 from the client device 30 or generated by the relay device 20 in order to prepare a response to the request from the client device 30. In either case, the joining request is delivered to the data management nodes N. Accordingly, the process of FIG. 6 is performed by the respective data management nodes N in parallel. However, for convenience, description with reference to FIG. 6 will be made by paying attention to a single data management node N. The data management node N to be paid attention to is referred to as “its own node”. Delivery of the joining request to the respective data management nodes N may be implemented through, for example, broadcasting by the relay device 20 or a series of chained transfers between the data management nodes N.

The depository identifying unit 12 reads a record Rb from the table Tb, which is one of the tables to be joined, of its own node (S102). The processing after S102 in FIG. 6 may be performed on each record Rb of the table Tb of its own node either in series or in parallel. Here, for convenience, it is assumed that the processing is performed in series and the read record Rb is referred to as a “target record Rb”. Accordingly, the processing after S102 is repeated by the number of records Rb stored in its own node.

Subsequently, the depository identifying unit 12 refers to the depository information storing unit 112 of its own node to identify a depository node of a record Ra (hereinafter, referred to as a “target record Ra”) having, as a value of the item A, a value of the item X of the target record Rb (S103).

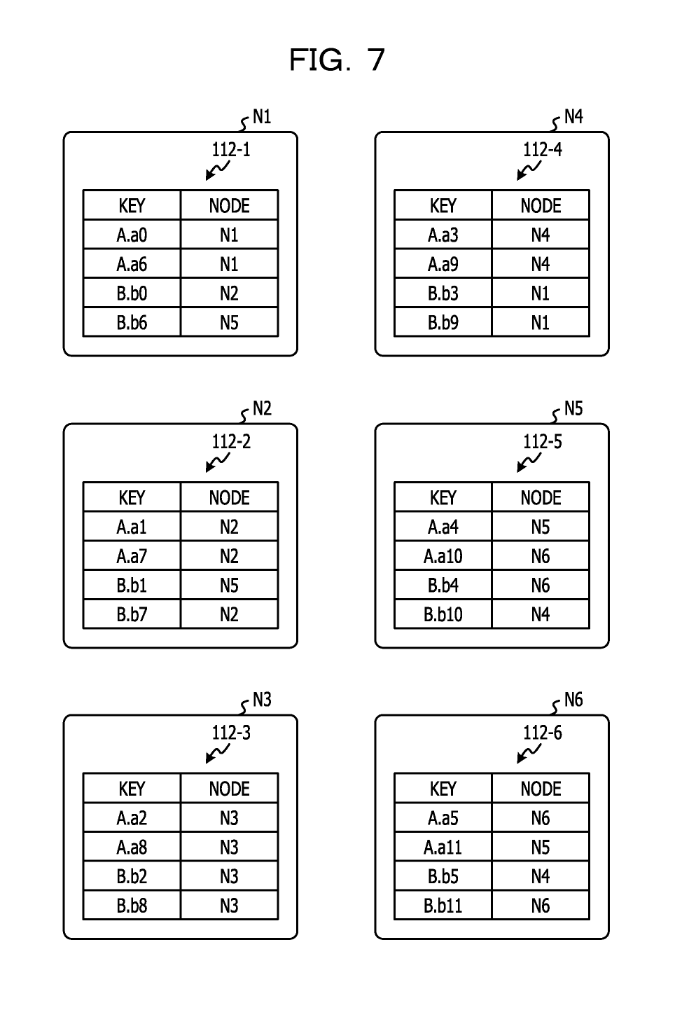

FIG. 7 is a diagram illustrating exemplary stored contents of depository information storing units in respective data management nodes. In FIG. 7, exemplary stored contents of the depository information storing units 112-1 to 112-6 in respective data management nodes N1 to N6 are illustrated. When intending not to distinguish respective depository information storing units 112-1 to 112-6, the depository information storing units 112-1 to 112-6 are collectively referred to as a “depository information storing unit 112”.

As illustrated in FIG. 7, the depository information storing unit 112 stores therein information (depository information) indicating a data management node N which manages each record Ra or each record Rb. Specifically, the depository information storing unit 112 stores therein identification information (hereinafter, referred to as a “node number”) of a depository node of a record in association with a key of the record Ra or the record Rb. The depository information storing unit 112 in each data management node N dispersedly stores the depository information in accordance with a predetermined distribution rule. That is, the stored contents of the depository information storing unit 112 in each of the data management nodes N1 to N6 may be integrated so as to obtain the depository information about all the records Ra and records Rb. The depository information is generated, for example, either after placing data (record Ra or record Rb) on each data management node N or at the same time as placement of data. A depository node of each data is not determined before placing data so that the depository information may not be generated before placing the data. At the beginning of operation of the data management system 1, a placement destination of the depository information is determined based on, for example, the key in each piece of depository information. Accordingly, the data management node N in which the depository information of a certain record Ra or record Rb is recorded may be identified based on the key of the record Ra or the record Rb. However, the depository information may be distributed in accordance with other distribution rules.

In the present embodiment, a key of a record Ra is a hash value of the item A of the record Ra. A key of a record Rb is a hash value of the item B of the record Rb. For convenience, a key of a record Ra is represented by “A. <value of the item A>” in the present embodiment. The letter “A” ahead of “.” is an identifier of the table Ta. A key of a record Rb is represented by “B. <value of the item X>” for convenience. The letter “B” ahead of “.” is an identifier of the table Tb.

At S103, when it is determined that the depository information including a key of a target record Ra is stored in the depository information storing unit 112 of its own node (“YES” at S104), the depository node is identified based on a node number included in the depository information. Here, the key of the target record Ra is obtained by a hash value of the item X of the target record Rb.

When it is determined that the depository information including the key of the target record Ra is not stored in the depository information storing unit 112 of its own node (“NO” at S104), the depository identifying unit 12 of its own node inquires of a data management node N (hereinafter, referred to as an “other node” in the description of FIG. 6) identified based on the key of the target record Ra about the depository node (S105). Specifically, the depository identifying unit 12 of its own node designates the key of the target record Ra and transmits a request to identify a depository node to the depository identifying unit 12 of the other node. This is because the depository information is distributed based on the key of the record Ra or the record Rb so that the depository information regarding the target record Ra is stored in the depository information storing unit 112 of the other node identified based on the key of the record Ra. The depository identifying unit 12 of the other node acquires a node number associated with the key of the record Ra from the depository information storing unit 112 of the other node and replies the acquired node number.

The data manipulating unit 13 of its own node determines whether the depository node is its own node (S106). Specifically, it is determined whether the node number identified at S103 or S105 is the node number indicating its own node.

When it is determined that the depository node is its own node (“YES” at step S106), the data manipulating unit 13 of its own node acquires the target record Ra from the table Ta stored in the data storing unit 111 of its own node (S107). Subsequently, the response replying unit 15 of its own node replies a result of joining the target record Ra with the target record Rb to the relay device 20 (S108).

When it is determined that the depository node is not its own node (“NO” at step S106), the data moving unit 16 of its own node transmits the target record Rb to the depository node and requests the depository node to register the target record Rb (S109). In accordance with the request, the depository node registers the target record Rb with the table Tb of the data storing unit 111 of the depository node. Details of the processing sequence performed in the depository node In accordance with the request will be described later.

When registration is normally performed in the depository node, the data moving unit 16 of its own node deletes the target record Rb from the table Tb (S110). Subsequently, the depository information updating unit 14 of its own node updates the depository information of the target record Rb in the depository information storing unit 112 of its own node (S111). Specifically, the node number of the depository information is overwritten by the node number of the data management node N which is a movement destination of the target record Rb.

As described above, in the present embodiment, the record Ra and the record Rb that are joined with each other are stored in the same data management node N. That is, the locality regarding the location of placement between the joined record Ra and record Rb is secured. As a result, when a joining of the table Ta and the table Tb is requested next time or after, the communication frequency at S109 may be reduced. An improvement of responsiveness may be expected as a result of the decrease in the communication frequency.

Various known logics may be used for a logic to secure the locality regarding the location of placement between the joined record Ra and record Rb. For example, securing of the locality (moving of the record Rb) may be performed for a case where the same joining request has been performed a predetermined number of times or more.

Subsequently, a processing sequence performed by a data management node N which becomes a transmission destination of the target record Rb at S109 will be described.

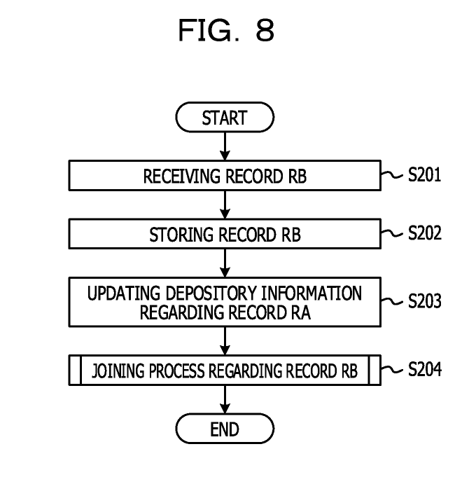

FIG. 8 is a flowchart of an exemplary processing sequence performed by the data management node in response to receipt of a data registration request from the other node. In the description of FIG. 8, the same terminologies as those of FIG. 6 are used with respect to the same components for descriptions in FIG. 6 and FIG. 8 by taking into account of the continuity with the description of FIG. 6. For example, the data management node N which performs the process of FIG. 8 is referred to as the “depository node”. However, the “requesting node” in the descriptions of FIG. 8 corresponds to the “its own node” in the description of FIG. 6.

At S201, the data registration unit 17 of the depository node receives the target record Rb transmitted from the requesting node. The data registration unit 17 of the depository node stores (registers) the target record Rb in the table Tb of the depository node (S202). The depository information updating unit 14 of the depository node updates the depository information regarding the target record Ra (S203). Specifically, the node number of the depository node is stored in the depository information storing unit 112 of the depository node by being associated with the key of the target record Ra (that is, a hash value of the item X of the target record Rb). When the depository information including the key of the target record Ra is already stored in the depository information of the depository node, the node number in the depository information is overwritten by the node number of the depository node.

Subsequently, the processing after S103 of FIG. 6 is performed with respect to the target record Rb by the depository node (S204). As a result, the result of joining the target record Rb with the record Ra, which has a value of the item X of the target record Rb as a value of the item A, is replied to the relay device 20.

As described above, in a data management node N as a new depository of the target record Rb, the depository information indicating that a depository node of the target record Ra, which is a counterpart for joining with the target record Rb, is the data management node N is stored in the depository information storing unit 112. As a result, it is possible to reduce the communication frequency of S105 of FIG. 6 needed for a case where the depository information is not managed at its own node.

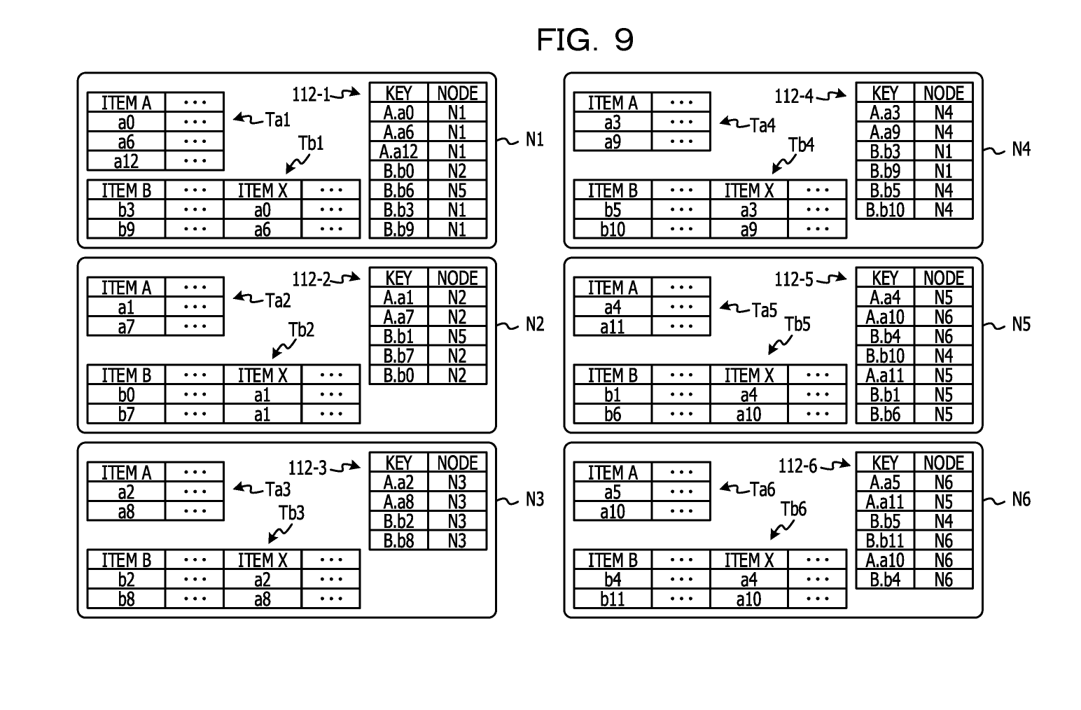

After the processes of FIG. 6 and FIG. 8 are performed, the distribution state of the record Ra groups and the record Rb groups distributed originally as illustrated in FIG. 2 and the depository information distributed originally as illustrated in FIG. 7 is changed into, for example, a state as illustrated in FIG. 9.

FIG. 9 is a diagram illustrating an example of change in a distribution state of a record Ra, record Rb, and the depository information. In FIG. 9, the contents of the table Tb of each data management node N are changed from those in FIG. 2. This is because a record Rb is moved to the depository node of a record Ra which is the counterpart for joining. Further, the stored contents of the depository information storing unit 112 of each data management node N are also changed. For example, the depository information regarding the record Ra being managed in its own node is added in the depository information storing unit 112 of each data management node N.

FIG. 9 does not completely illustrate a distribution state as a result of joining of the table Ta and the table Tb, for convenience.

The depository information stored in the depository information storing unit 112 may be collectively generated, for example, after the locality regarding the placement of the record Ra and the record Rb having a relevancy on each other is secured. Specifically, a state in FIG. 9 without the depository information may be formed first and then the depository information may be generated. An arbitrary logic may be employed to secure the locality.

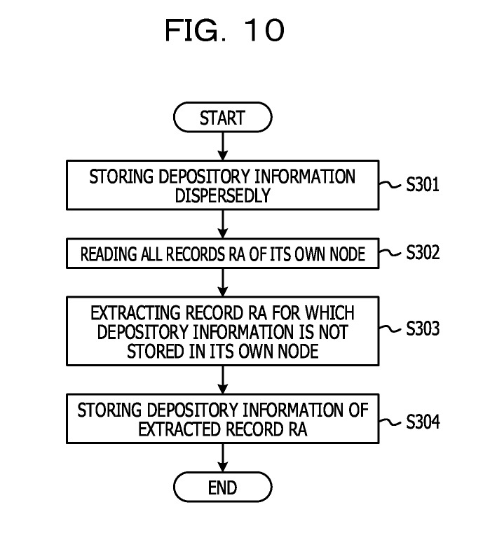

In this case, the depository information updating unit 14 of each data management node N performs, for example, a process illustrated in FIG. 10. FIG. 10 is a flowchart of an exemplary processing sequence for a collective generation process of the depository information.

At S301, the depository information updating unit 14 of each data management node N stores, in the depository information storing unit 112 of its own node, the depository information distributed and allocated to its own node, based on a predetermined distribution rule. For example, a data management node N to store the depository information is determined based on the key value of the depository information. The distribution of the depository information may be unitarily performed by the relay device 20. Each data management node N may receive, from the relay device 20, the depository information distributed and allocated to its own node by the relay device 20. When the process of FIG. 10 is not performed, that is, even when the depository information is not collectively generated, S301 is performed, for example, either after or simultaneously with placing data (the record Ra or the record Rb) to each data management node N.

The depository information updating unit 14 of each data management node N reads all the records Ra stored in the table Ta of its own node (S302). The depository information updating unit 14 extracts a record Ra, for which the depository information including the key of the record Ra is not stored in the depository information storing unit 112 of its own node, among the read records Ra (S303). The depository information updating unit 14 stores depository information, in which the node number of its own node is associated with the key of each extracted record Ra, in the depository information of its own node (S304).

According to the process described above, the depository information as illustrated in FIG. 9, for example, is also stored in each data management node N.

Subsequently, description will be made by applying the state of FIG. 9 to the processes described with reference to FIG. 6 and FIG. 8.

Each data management node N refers to the depository information storing unit 112 of its own node to identify a depository node of the record Ra to be joined with the record Rb stored in its own node, in accordance with a request to join the table Ta and the table Tb. In the example of FIG. 9, the depository node of the records Rb is identified to be its own node, based on the depository information of its own node, except for a record Rb (hereinafter, referred to as a “record Rb(b4)”) having “a4” and “b4” as the values of the item X and item B, respectively, in the table Tb6 of the node N6 and a record Rb (hereinafter, referred to as a “record Rb(b6)”) having “a10” and “b6” as the values of the item X and item B, respectively, in the table Tb5 of the node N5. That is, in the node N5, the node number in the depository information having the key of “A. a10” indicates the node N6, and depository information having the key of “A. a4” is not present in the node N6. Accordingly, each data management node N may perform joining with the record Rb other than the record Rb(b4) and the record Rb(b6) without communicating with other nodes. The record Rb such as the record Rb(b4) or the record Rb(b6) is generated in such a manner that a new record Rb is added in the table Tb after performing the joining of the table Ta and the table Tb or a record is moved by a manipulation other than the joining of the table Ta and the table Tb.

In this case, joining of 10 (ten) records Rb among 12 (twelve) records Rb are completed within respective nodes. Accordingly, the amount of communication is 2/12≈0.266 times as many as the total amount of data. This value becomes sufficiently smaller than {(the number of nodes−1)÷the number of nodes}=5÷6=0.8333. Accordingly, it may be considered that reduction of the amount of communication is achieved even when considering communications for updating the depository information.

The depository node of the record Rb(b4) is not able to be identified in the depository information of the node N6 and thus, the N5 is identified as having the depository information based on the hash value of “a4” which is the value of the item X of the record Rb(b4).

Accordingly, the node N6 inquires of the node N5 about the depository node of the key “A. a4”. The communication for the inquiry is referred to as a “communication_1” in the following.

The node N5 replies a response indicating that the depository node of the key “A. a4” is the node N5 to the node N6. The communication for the reply is referred to as a “communication_2” in the following.

The node N6 transmits the record Rb(b4) to the node N5. The communication for transmitting the record Rb(b4) is referred to as a “communication_3” in the following. The node N5 joins the received record Rb(b4) and a record Ra which includes the item A having a value identical with the value of the item X of the record Rb(b4).

Regarding the record Rb(b6), it is identified that the depository node of the record Ra which is a counterpart for joining is another node (in this case, node N6) without performing communication. Accordingly, the communication_1 and the communication_2 do not occur regarding the record Rb(b6).

Accordingly, the amount of communication during the joining becomes smaller than {the total amount of data×(the number of nodes−1)/the number of nodes}.

Specifically, the amount of communication according to the present embodiment is represented by the following expression (1).

(1−α)×(N−1)/N×(communication_{—}1+communication_{—}2)+(1−α)×communication_{—}3 (1)

Here, α indicates a probability that the relevant data (a set of records to be joined in the present embodiment) are placed to be localized (placed in the same node) and is sufficiently large. N is the number of nodes.

The amount of the communication_3 is the total amount of data. The communication_1 and communication_2 are information indicating the data of the item X or the depository node and thus, these are also small enough to be neglected.

Accordingly, the locality in placement of data having a relevancy on each other may be secured according to the present embodiment. Therefore, the amount of communication for manipulation performed on two or more pieces of data, such as a join manipulation, may be reduced. Depository information of each data is stored in the depository information storing unit 112 according to the present embodiment. Accordingly, the amount of communication needed for identifying the location of placement (depository node) of the data to be manipulated may be reduced.

When the number of records of the depository information is small as in a case where the amount of data to be managed is small, the same depository information may be copied to all the data management nodes N. However, when the moving of data frequently occurs, the communication for synchronizing the depository information of each data management node N occurs, so that the depository information may also be dispersedly managed for such a case, as described above.

In the present embodiment, data which becomes a counterpart for joining, that is, two pieces of data having a value of a predetermined item in common, is used as an example of data having a relevancy on each other, but the present embodiment may be applied to data having other relevancy. For example, the present embodiment may be applied to pieces of data having a high frequency of being continuously referenced or having a high frequency of being continuously recorded.

In the present embodiment, the data management node N is an example of a data storage device. The depository information storing unit 112 is an example of a storing unit.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a first computer of a plurality of computers to execute a process, the plurality of computers dispersedly storing pieces of data and pieces of depository information of the respective pieces of data, the depository information indicating a depository computer storing data of the pieces of data, the process comprising:
storing, when depository information of first data is absent in a first storing unit of the first computer, first depository information in the first storing unit, the first depository information indicating the first computer as a first depository computer storing the first data, the first data being stored in a second storing unit of the first computer; and
identifying, by searching the first storing unit, a second computer as a second depository computer storing second data to be manipulated in association with third data stored in the second storing unit.

2. The non-transitory computer-readable recording medium according to claim 1, wherein the plurality of computers dispersedly store the pieces of depository information on basis of a predetermined rule, the process further comprising:
inquiring of a third computer about the second depository computer when the second computer is not identified by searching the first storing unit, the third computer being identified on basis of the predetermined rule.

3. The non-transitory computer-readable recording medium according to claim 1, the process further comprising:
receiving the second data from the second computer;
storing the received second data in the second storing unit; and
storing, in the first storing unit, second depository information indicating the first computer as the second depository computer.

4. A method for processing data, the method comprising:
dispersedly storing, by a plurality of computers, pieces of data and pieces of depository information of the respective pieces of data, the depository information indicating a depository computer storing data of the pieces of data;
storing by a first computer of the plurality of computers, when depository information of first data is absent in a first storing unit of the first computer, first depository information in the first storing unit, the first depository information indicating the first computer as a first depository computer storing the first data, the first data being stored in a second storing unit of the first computer; and
identifying by the first computer, by searching the first storing unit, a second computer as a second depository computer storing second data to be manipulated in association with third data stored in the second storing unit.

5. The method according to claim 4, wherein the plurality of computers dispersedly store the pieces of depository information on basis of a predetermined rule, the method further comprising;
inquiring of, by the first computer, a third computer about the second depository computer when the second computer is not identified by searching the first storing unit, the third computer being identified on basis of the predetermined rule.

6. The method according to claim 4, further comprising:
receiving, by the first computer, the second data from the second computer;
storing, by the first computer, the received second data in the second storing unit; and
storing in the first storing unit, by the first computer, second depository information indicating the first computer as the second depository computer.
